(19) United States
(12) Patent Application Publication
(10) Pub. No.: US 2025/0183254 A1
(43) Pub. Date: Jun. 5, 2025

(54) INDIVIDUALIZED BATTERY FORMATION SYSTEMS

(71) Applicant: Apple Inc., Cupertino, CA (US)

(72) Inventors: Rajesh Kandibanda, Menlo Park, CA (US); Rejin Isaac, San Jose, CA (US); Liubin Zhou, Shenzhen (CN); Samuel C. Billand, San Jose, CA (US); Aviran Malik, San Jose, CA (US); Nath B. Chhiv, Alameda, CA (US); Mark E. Wilcox, Morgan Hill, CA (US); Scott M. Nathanson, Los Gatos, CA (US)

(73) Assignee: Apple Inc., Cupertino, CA (US)

(21) Appl. No.: 18/939,367

(22) Filed: Nov. 6, 2024

Related U.S. Application Data
(60) Provisional application No. 63/604,784, filed on Nov. 30, 2023.

(51) Int. Cl. H01M 4/04; B30B 15/00; B30B 15/06

(52) U.S. Cl. CPC H01M 4/043; B30B 15/0041; B30B 15/064

(57) ABSTRACT

A battery formation system, comprising a first pressing platform, a second pressing platform, and a press assembly configured to move the first pressing platform towards the second pressing platform to apply a pressing force on an unfinished battery. The first pressing platform is coupled to the press assembly and rotatable relative to the second pressing platform. The battery formation system further comprises a pressure film sensor coupled to the pressing platform and configured to output pressure data corresponding to the pressing force, and a computer system in communication with the pressure film sensor. The computer system includes one or more computer processors configured to receive the pressure data from the pressure film sensor, determine, based on the pressure data, pressure information that is representative of the first pressing platform, and send instructions to adjust an angle of the first pressing platform based on the pressure information.

### CROSS-REFERENCES TO RELATED APPLICATIONS

This application claims priority under 35 U.S.C. § 119 (e) to U.S. Provisional Application Ser. No. 63/604,784, filed Nov. 30, 2023, entitled “INDIVIDUALIZED BATTERY FORMATION SYSTEMS,” which is incorporated herein by reference in its entirety.

### BACKGROUND

Battery cells may be formed by stacking layers to define various form factors. However, conventional methods of producing layered battery cells may lead to a structure having layers that are insufficiently adhered to each other, which may cause performance issues for layered battery cells. Accordingly, a need exists to optimize the manufacturing process of forming layered battery cells.

### BRIEF SUMMARY OF THE INVENTION

One aspect of the disclosure provides for a battery formation system, comprising a first pressing platform, a second pressing platform, and a press assembly configured to move the first pressing platform towards the second pressing platform to apply a pressing force on an unfinished battery. The first pressing platform is coupled to the press assembly and rotatable relative to the second pressing platform. The battery formation system further comprises a pressure film sensor coupled to the pressing platform and configured to output pressure data corresponding to the pressing force, and a computer system in communication with the pressure film sensor. The computer system includes one or more computer processors configured to receive the pressure data from the pressure film sensor, determine, based on the pressure data, pressure information that is representative of the first pressing platform, and send instructions to adjust an angle of the first pressing platform based on the pressure information. The battery formation system may further comprise a laser emitter coupled to the pressing platform and in communication with the computer system. The laser emitter may be configured to output angle data corresponding to an angle of the first pressing platform, and the one or more computer processors may be configured to receive the output angle data from the laser emitter, determine, based on the output angle data, position information that may be representative of the first pressing platform, and send instructions to adjust the angle of the first pressing platform based on the position information. The laser emitter may be coupled to a corner of the first pressing platform. The battery formation system may further comprise a first compliant pad coupled to the first pressing platform and a second compliant pad coupled to the second pressing platform. The press assembly may be configured to move the first compliant pad toward the second compliant pad to apply the pressing force on the unfinished battery. The battery formation system may further comprise a heating plate coupled to the first pressing platform, wherein the heating plate may be configured to provide heat to the unfinished battery at a temperature. The battery formation system may further comprise a temperature film sensor coupled to the heating plate and in communication with the computer system. The temperature film sensor may be configured to output temperature data corresponding to the temperature of the heat provided by the heating plate to the unfinished battery, and the one or more computer processors may be configured to receive the output temperature data from the temperature film sensor, determine, based on the output temperature data, temperature information that may be representative of the heating plate, and send instructions to adjust at least one of: (i) the angle of the first pressing platform based on the temperature information, and (ii) the temperature of the heating plate. The battery formation system may further comprise a second pressure film sensor coupled to the second pressing platform, wherein the second pressure film sensor may be configured to output second pressure data corresponding to the pressing force. The battery formation system may further comprise an adjustment plate coupled to the press assembly, a swivel joint rotatably received in the adjustment plate, and a swivel fastener coupled to the swivel joint. The first pressing platform may be coupled to the swivel fastener. The battery formation system may further comprise a plurality of adjustment fasteners movably received in the adjustment plate. The first pressing platform may abut against the plurality of adjustment fasteners. In a first state, the first pressing platform may be in a first angle relative to the second pressing platform and the plurality of adjustment fasteners are in a first position relative to the adjustment plate, and in a second state, the second pressing platform may be in a first angle relative to the second pressing platform and at least one adjustment fastener of the plurality of adjustment fasteners may be in a second position relative to the adjustment plate, and the first angle and the first position may be respectively different than the second angle and the second position.

Another aspect of the disclosure provides for a battery formation system, comprising a first pressing platform, a second pressing platform, a press assembly configured to move the first pressing platform towards the second pressing platform to apply a pressing force on an unfinished battery. The first pressing platform is coupled to the press assembly and rotatable relative to the second pressing platform. The battery formation system further comprises a pressure sensor matrix coupled to the pressing platform and configured to output pressure data corresponding to the pressing force, and a laser emitter coupled to the first pressing platform and configured to output angle data corresponding to an angle of the first pressing platform. The laser emitter may be coupled to a corner of the first pressing platform. The battery formation system may further comprise a first compliant pad coupled to the first pressing platform and a second compliant pad coupled to the second pressing platform. The press assembly may be configured to move the first compliant pad toward the second compliant pad to apply the pressing force on the unfinished battery. The battery formation system may further comprise a heating plate coupled to the first pressing platform. The heating plate may be configured to provide heat to the unfinished battery. The battery formation system may further comprise a temperature film sensor coupled to the heating plate and in communication with a computer system. The temperature film sensor may be configured to output temperature data corresponding to the heat provided by the heating plate to the unfinished battery. The battery formation system may further comprise a second pressure film sensor coupled to the second pressing platform, wherein the second pressure film sensor may be configured to output second pressure data corresponding to the pressing force. The battery formation system may further comprise an adjustment plate coupled to the press assembly, a swivel joint rotatably received in the adjustment plate, and a swivel fastener coupled to the swivel joint. The first pressing platform may be coupled to the swivel fastener. The battery formation system may further comprise a plurality of adjustment fasteners movably received in the adjustment plate. The first pressing platform may abut against the plurality of adjustment fasteners. In a first state, the first pressing platform may be in a first angle relative to the second pressing platform and the plurality of adjustment fasteners are in a first position relative to the adjustment plate, in a second state, the second pressing platform may be in a first angle relative to the second pressing platform and at least one adjustment fastener of the plurality of adjustment fasteners may be in a second position relative to the adjustment plate, and the first angle and the first position may be respectively different than the second angle and the second position.

Another aspect of the disclosure provides for a battery, comprising a battery enclosure defining an interior volume, and a battery cell positioned in the interior volume. The battery cell includes a first active material layer, a second active material layer, and a separator layer coupled between the first active material layer and second active material layer. The first active material layer, second active material layer, and the separator are rolled such that the battery cell forms a wound battery cell configuration. The battery cell includes a plurality of layers that are substantially uniform.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A depicts a schematic view of a battery formation system according to one aspect of the disclosure.

FIG. 1B depicts a schematic view of a pressing system of the battery formation system of FIG. 1A.

FIG. 2 depicts an example sensing matrix according to one aspect of the disclosure.

FIG. 3A depicts a perspective view of a pressing system according to one aspect of the disclosure.

FIG. 3B depicts a cross-sectional view of the pressing system of FIG. 3A along cross-sectional plane 3B-3B.

FIG. 3C depicts a cross-sectional view of the pressing system of FIG. 3B when the first pressing platform is adjusted.

FIG. 4 depicts a cross-sectional view of a pressing system according to one aspect of the disclosure.

FIG. 5 depicts a cross-sectional view of a pressing system according to one aspect of the disclosure.

FIG. 6 depicts a cross-sectional view of a battery according to one aspect of the disclosure.

FIG. 7 depicts an example flowchart for forming a battery using a computer system according to one embodiment of the disclosure.

FIG. 8 depicts a block diagram of an example computer system usable with systems and methods according to embodiments of the present disclosure.

### DETAILED DESCRIPTION OF THE INVENTION

The present disclosure is directed to a battery formation system of forming battery cells having a wound battery cell structure (e.g., jelly roll structures or the like). Forming such battery cells may include rolling up various layers (e.g., current collector layers, cathode and anode active material layers, separators, and the like). These wound battery cells may be inserted into a battery enclosure, such as a pouch, and electrolyte may be injected within the battery enclosure to form an unfinished battery. A plurality of other unfinished batteries may be formed with similar steps. The unfinished batteries may then be positioned on a pressing platform to form a sheet of unfinished batteries. Multiple sheets of the unfinished batteries may be compressed to increase the adhesion of the layers in the wound battery cell together (e.g., by ensuring that each of the layers sufficiently contact the wet adhesion between the layers). Once the unfinished battery is compressed, the unfinished battery may be heated in the process of forming a plurality of finished batteries (or the result of unfinished batteries after being compressed and, in some embodiments, heated). Compressing the unfinished battery may decrease the overall size of the battery cells, as well as increasing the adhesion of each of the layers of the wound battery cell to each other, leading to better performance of the battery cell.

In one example of a conventional battery formation system, a single press may be used to press multiple of the unfinished batteries at the same time. For example, a single press may be used to press multiple stacked sheets of the unfinished batteries. However, compressing multiple stacked sheets of unfinished batteries together can form uneven wound battery cell structures in the battery cells. For example, some of the wound battery cells may have different sizes (e.g., from being rolled up in different ways or from having slightly different quantities of electrolyte), which leads to certain unfinished batteries receiving different pressure profiles (e.g., distributions of pressure) than other unfinished batteries. Further, the difference in size of some unfinished batteries will change the angle of the press for other unfinished batteries such that at least some of the unfinished batteries will receive an uneven pressure profile. Such unevenness and differences in pressure profile may also be exacerbated by structural distortions in the unfinished batteries. For example, certain features of the layers of the wound battery cell (e.g., the various tabs, tapes, and coatings of the wound battery cells) may cause the layers of the wound battery cell to be uneven when the layers are wrapped about these features. This can be an especially important issue in smaller battery cells (e.g., smaller wound battery cells) with high-voltage chemistries, as the tabs, tapes, and coatings can account for a larger percentage of the total volume of these smaller battery cells.

This uneven pressure profile may result in battery cells with layers that are not optimally adhered together. For example, without sufficient and even pressure, the innermost layers of the wound battery cell may not sufficiently contact the wet adhesion between the layers and may later unfurl. This lack of adhesion may result in the battery cells swelling and having decreased performance, as well as more rapidly failing over time. Further, this uneven pressure can lead to, or compound with, an uneven temperature profile applied to the unfinished battery. For example, an uneven temperature could lead to uneven initial thickness of the finished battery, uneven swelling during cell cycling, and worse battery performance.

The present disclosure provides for a battery formation system with an individual pressing system for each unfinished battery. The pressing system may include film sensors that detect the temperature and pressure profile applied to the unfinished battery during formation. Additionally, the pressing system may include laser emitters to detect whether the angle of the pressing platform changes while compressing the unfinished battery. The temperature, pressure, and/or the angle of the pressing platform may be adjusted to provide a more even pressure or temperature profile for the unfinished battery, thus forming a battery cell with greater layer adhesion and greater performance.

Although the remaining portions of the description may routinely reference lithium-ion battery cells, it will be readily understood by the skilled artisan that the technology is not so limited. The present designs may be employed with any number of battery or energy storage devices, including other rechargeable and primary, or non-rechargeable, cell types, as well as electrochemical capacitors also known as supercapacitors or ultracapacitors, electrolysers, fuel cells, and other electrochemical devices. Moreover, the present technology may be applicable to battery cells and energy storage devices used in any number of technologies that may include, without limitation, phones and mobile devices, handheld electronic devices, wearable devices, laptops and other computers, appliances, heavy machinery, transportation equipment, spacecraft electronics payloads, vehicles, as well as any other device that may use battery cells or benefit from the discussed designs. Accordingly, the disclosure and claims are not to be considered limited to any particular example discussed, but can be utilized broadly with any number of devices that may exhibit some or all of the electrical or chemical characteristics of the discussed examples.

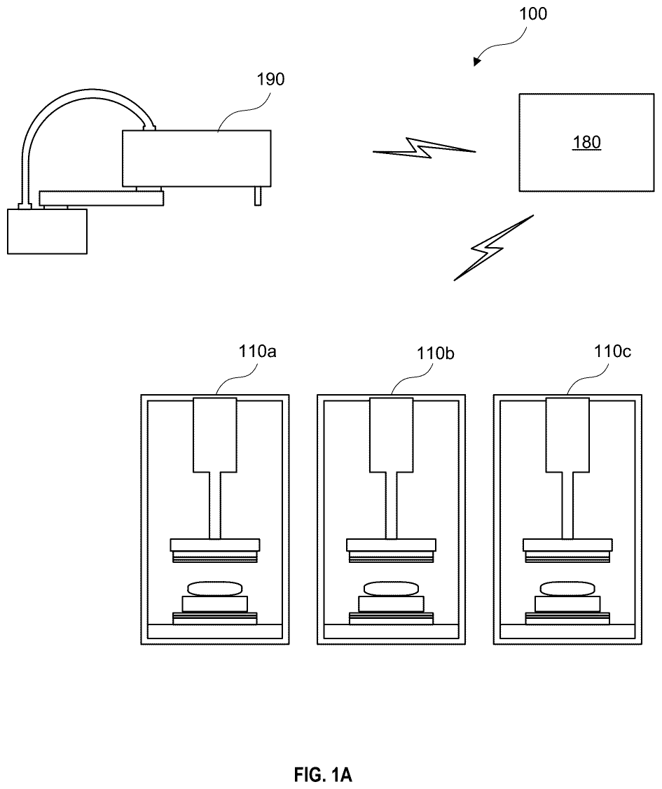

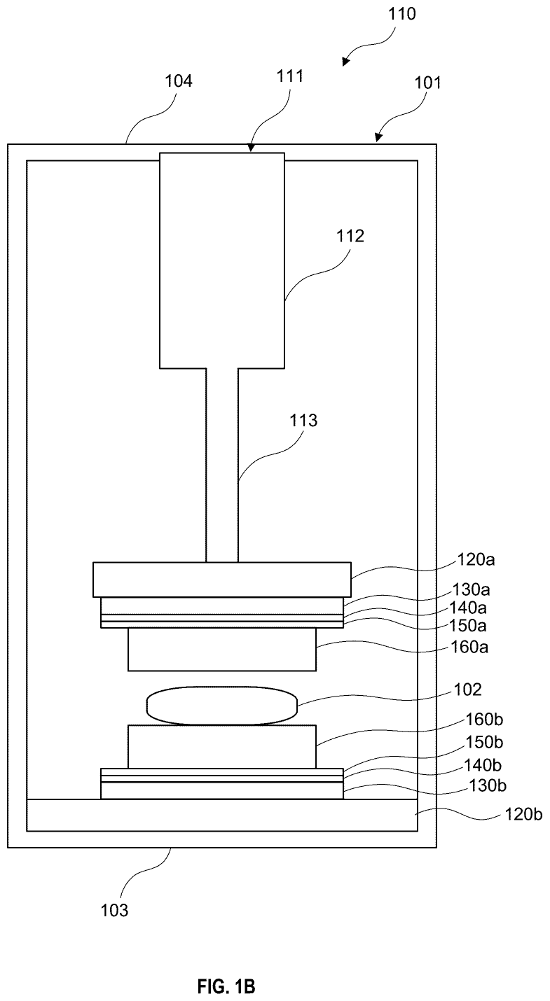

FIGS. 1A and 1B depict a battery formation system 100. Turning to FIG. 1A, the battery formation system 100 may include a manipulator 190, a first pressing system 110a, a second pressing system 110b, a third pressing system 110c, and computer system 180. The manipulator 190 and the pressing systems 110a, 110b, 110c may be in communication with a computer system 180 (e.g., similar to the computer system 710, as discussed further below), which may provide instructions to one or more of the manipulator 190 and the pressing systems 110a, 110b, 110c to perform the functions as described below. Each of the pressing systems 110a, 110b, 110c may press individual unfinished batteries. Although three pressing systems 110a, 110b, 110c are depicted, in other embodiments, there may be more or less pressing systems, such as one, two, four, five, or the like. The manipulator 190 may be a robotic manipulator that transfers unfinished batteries and finished batteries to and from the pressing systems 110a, 110b, 110c.

FIG. 1B depicts a pressing system 110 that is representative of any of the pressing systems 110a, 110b, 110c used in the battery formation system 100. The battery system 100 may include a frame 101 with a top end 104 and a bottom end 103. A pressing assembly 111 may be coupled to the top end 104. The press assembly 111 may include a motor 112 and a shaft 113 extending from the motor 112. The motor 112 may be actuated to move the shaft 113 closer and further from the motor 112. The motor 112 may include a servo motor, however, in other embodiments, the motor may include a linear actuator, hydraulic press, or the like. A first pressing platform 120a may be coupled to the shaft 113 such that the motor 112 may move the shaft 113 and the first pressing platform 120a in tandem. Further, as will be discussed further below, the first pressing platform 120a may be rotatable relative to the motor 112. A second pressing platform 120b may be coupled to the bottom end 103 of the frame 101. The second pressing platform 120b may house one or more electronic components that facilitate the functions of the pressing system 110. The pressing platforms 120a, 120b may be a rigid metallic plate made of stainless steel, titanium, or other rigid metals. An unfinished battery 102, and one or more other components, may be positioned between the pressing platforms 120a, 120b such that the unfinished battery 102 may be compressed therebetween. Specifically, the motor 112 may move the shaft 113 and the first pressing platform 120a towards the second pressing platform 120b to compress the unfinished battery 102 therebetween.

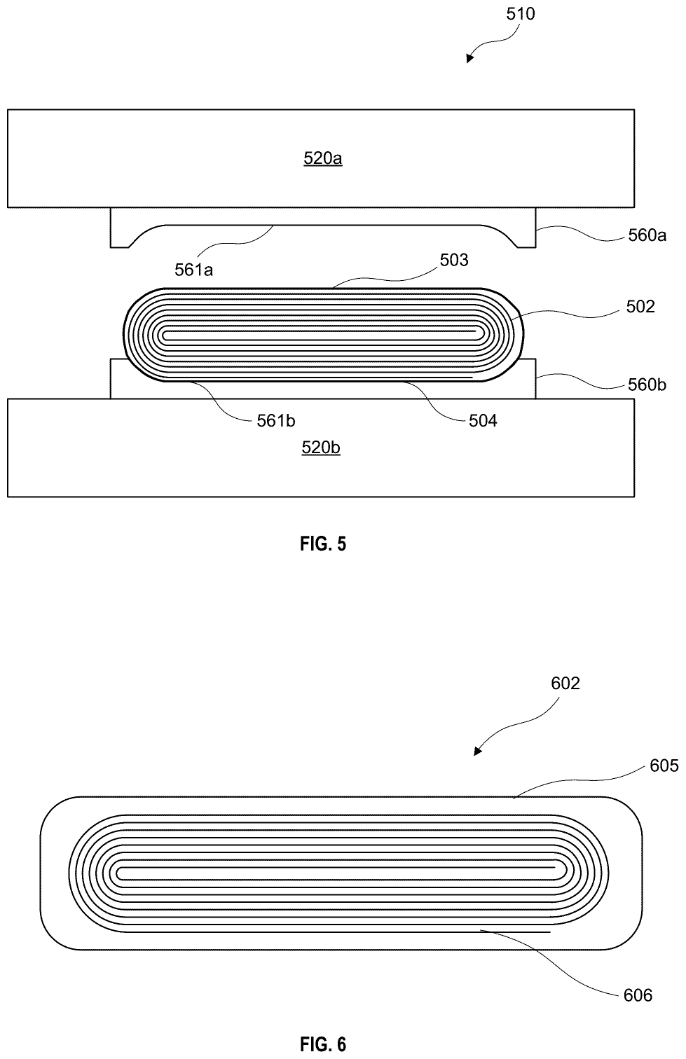

As noted above, battery cells that did not receive an even pressure profile may result in the layers of that battery cell not being sufficiently adhered to each other, which may result in the battery cells swelling and having decreased performance, as well as more rapidly failing over time. The battery formation system 100 addresses this issue by providing pressing systems 110a, 110b, 110c that individually press each unfinished battery 102 so that each unfinished battery 102 can receive a pressure profile specific to that unfinished battery 102. Further, each of the pressing systems 110 in the battery formation system 100 include a number of features that can analyze the pressure profile applied to the unfinished battery 102 and make adjustments to ensure that an even pressure is applied to the unfinished battery 102. The adjustments can also ensure that, later on, other unfinished batteries sharing properties (e.g., number of layers, materials, sizes, etc.) with the analyzed unfinished battery 102 receive an even pressure. Accordingly, the battery formation system 100 may form a battery, from the unfinished battery 102, with layers that are more uniformly adhered to each other, such as the battery 502 shown in FIG. 5. The adjustments may be made automatically through instructions received from a computer system or manually from an operator.

The pressing system 110 may include a respective first and second heating plate 130a, 130b, a respective first and second temperature film sensor 140a, 140b, a respective first and second pressure film sensor 150a, 150b, and a respective first and second pad 160a, 160b. The heating plates 130a, 130b may be coupled to the pressing platforms 120a, 120b. The heating plates 130a, 130b may heat the unfinished battery 102 after the unfinished battery 102 has been compressed. As each individual unfinished battery 102 is receiving a custom temperature profile from the heating plates 130a, 130b, the tolerances for adjusting the heat applied to the unfinished battery 102 (e.g., around 0.2-0.3° C.) may be smaller compared to other embodiments where heat is applied to sheets of multiple unfinished batteries (e.g., around 2-3° C.). Accordingly, the heat provided to the unfinished battery 102 can be fine-tuned to be more specific to the unfinished battery 102. Further, the custom temperature profile enables each unfinished battery 102 to receive a more even temperature profile specifically tailored to each unfinished battery 102, which can produce a more even thickness of the finished battery, decrease uneven swelling during cell cycling, and provide better battery performance

The temperature film sensors 140a, 140b may be coupled to the heating plates 130a, 130b. The temperature film sensors 140a, 140b may include one or more resistance temperature detectors, or other type of temperature sensors, that measures the temperature profile applied across a surface area of the unfinished battery 102. The pressure film sensors 150a, 150b may be coupled to the temperature film sensors 140a, 140b. The pressure film sensors 150a, 150b may include one or more piezoelectric sensors, or other type of pressure sensors, that measures the pressure profile across a surface area of the unfinished battery 102. Positioning the film sensors 140a, 140b, 150a, 150b closer to the cell may ensure that the most accurate measurements for the unfinished battery 102 is detected. For example, it may be preferable to prioritize the pressure profile applied to the unfinished battery 102 over the temperature profile. In this case, it may be more preferable to place the pressure film sensors 150a, 150b closer to the unfinished battery 102 than the temperature film sensors 140a, 140b. However, in other embodiments, the positions of the film sensors may be changed. For example, the pressure film sensors may be coupled between the heating plates and the temperature film sensors. In a yet further embodiment, the heating plate may be positioned between the respective temperature and pressure film sensors. In other embodiments, there may only be one of the temperature or pressure film sensors. In another embodiment, there may be neither a temperature nor pressure film sensor. In a further embodiment, there may be additional types of film sensors, such as humidity film sensors, corrosion film sensors, or the like.

The battery formation system 100 may include a first pad 160a and a second pad 160b coupled to the pressure film sensors 150a, 150b. As will be discussed further below, the pads 160a, 160b may be compliant such that the pads 160a, 160b conform to an exterior surface of the unfinished battery 102 to more evenly apply pressure to the unfinished battery 102. Although two pads 160a, 160b are shown, in other embodiments, there may only be one pad (e.g., one top pad or one bottom pad).

The film sensors 140a, 140b, 150a, 150b may be in communication with the computer system 180 such that the film sensors 140a, 140b, 150a, 150b send the measurements to the computer system 180 for analysis. In this manner, as the pressing system 110 compresses and heats the unfinished battery 102, the computer system 180 may use the measurements provided by the film sensors 140a, 140b, 150a, 150b to generate a temperature and pressure sensing matrix that depicts the temperature and pressure profile applied across the surface area of the unfinished battery 102. For example, the pressure film sensors 150a, 150b may send measurements to the computer system 180 of the pressure profile being applied to the unfinished battery 102 so that the computer system 180 can generate a pressure sensing matrix depicting the pressure profile being applied to the unfinished battery 102 by the pressing platforms 120a, 120b. The temperature film sensors 140a, 140b may similarly send measurements to the computer system 180 of the temperature profile being applied to the unfinished battery 102 so that the computer system 180 can generate a temperature sensing matrix depicting the temperature profile being applied to the unfinished battery 102.

The unfinished battery 102 may include a battery cell including one or more of a cathode active material layer, anode active material layer, separator, and current collector. In some embodiments, although the battery cell may be composed of one layer each of anode and cathode active material as sheets, the layers may also be formed into a wound battery cell design, or folded design, prismatic design, or any form such that any number of layers may be included in the battery cell. For embodiments which include multiple layers, tab portions of each anode current collector may be coupled together, as may be tab portions of each cathode current collector. The unfinished battery 102 may house the battery cell in an enclosure (e.g., a pouch, a rigid housing, such as a rigid metallic can, or the like) to contain electrolyte and other materials.

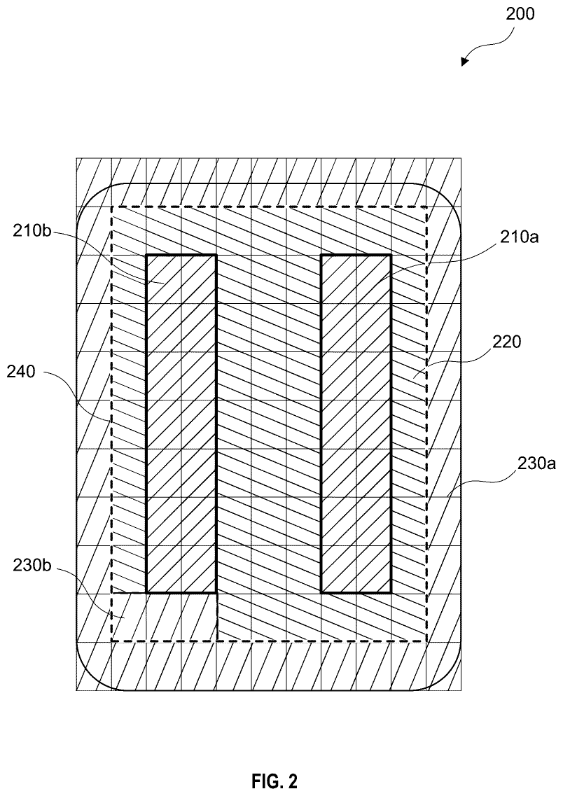

An example sensing matrix can be found in FIG. 2. The sensing matrix 200 may be a visual representation generated by a computer system (e.g., the computer system 180) based on film sensor measurements from a film sensor (e.g., the film sensors 140a, 140b, 150a, 150b). For example, the sensing matrix 200 may represent the pressure profile provided by a pressure film sensor (e.g., the pressure film sensor 150a, 150b) or the temperature profile provided by a temperature film sensor (e.g., the temperature film sensor 140a, 140b) on an unfinished battery. However, the sensing matrix 200 may represent the sensor measurements provided by other types of film sensors used when compressing and heating an unfinished battery.

The sensing matrix 200 may be a heatmap having sensor areas of the film sensor that detect sensor measurements on a corresponding portion of the unfinished battery. The sensing matrix 200 can depict sensor measurements at a high resolution. For example, the sensing matrix 200 can depict sensor measurements to a surface area of less than about 5 mm², such as less than about 3 mm², such as less than about 2 mm², such as less than about 1 mm², or such as less than about 0.5 mm². The sensing matrix 200 may include a first high sensor area 210a and a second high sensor area 210b representing areas of the unfinished battery receiving sensor measurements having a high value, a medium sensor area 220 representing areas of the unfinished battery receiving sensor measurements having a medium value, and a first low sensor area 230a and a second low sensor area 230b representing areas of the unfinished battery receiving sensor measurements having a low value. Each of the high sensor areas 210a, 210b, medium sensor area 220, and low sensor areas 230a, 230b may be visually represented as different colors or patterns, such as red for the high sensor areas 210a, 210b, yellow for the medium sensor area 220, and green for the low sensor areas 230a, 230b.

Each of the sensor areas 210a, 210b, 220, 230a, 230b may represent a range of pre-determined values set prior to use. For example, the low sensor areas 230a, 230b may represent values closer to the lower limit of the range and the high sensor areas 210a, 210b may represent values closer to the upper limit of the range. In one particular example, the low sensor areas 230a, 230b may represent a value of substantially zero, thus representing areas of the film sensor that are not receiving sensor measurements and indicating areas of the film sensor that are not in contact with the unfinished battery. For example, the low sensor areas 230a, 230b may represent sensor measurement values of less than about 5% of the sensor measurement values of the high sensor areas 210a, 210b, such as less than about 3% of those sensor measurement values, less than about 2% of those sensor measurement values, less than 1% of those sensor measurement values, or completely zero. Accordingly, only the high sensor areas 210a, 210b and the medium sensor area 220 may represent areas of the film sensor that are in contact with the unfinished battery. However, in other embodiments, the low sensor areas may also represent areas of the film sensor in contact with the unfinished battery but that are receiving low value sensor measurements greater than zero.

In some embodiments, the high sensor areas 210a, 210b, medium sensor area 220, and low sensor areas 230a, 230b may be equally distributed along that range (e.g., each of the three sensor areas 210a, 210b, 220, 230a, 230b represent a third of that range), however, in other embodiments, the sensor areas may be distributed in any manner (e.g., the high sensor area may represent the top 10% of a range, the low sensor area may represent the bottom 20% of the range, and the medium sensor area may represent the values therebetween). In a further embodiment, there may be more or less than three sensor areas. For example, the sensing matrix may include more than three sensor areas such that the sensing matrix depicts a smoother gradient between sensor areas. In other embodiments, the portions of the sensing matrix previously noted as high sensor areas may represent areas having low values of sensor measurements and the portions of the sensing matrix previously noted as high sensor areas may represent areas having high values of sensor measurements.

As will be discussed further below, where the sensing matrix 200 represents the temperature or pressure profile being applied to an unfinished battery, the sensing matrix 200 may be used to adjust an uneven pressure or temperature profile. For example, where the sensing matrix 200 represents the pressure profile being applied to an unfinished battery, the high sensor areas 210a, 210b may indicate areas of an unfinished battery that are receiving higher pressure than the areas of the unfinished battery corresponding to the medium sensor area 220. The pressing system may then be adjusted (e.g., the angle of the first pressing platform 120a of the pressing system 110 may be adjusted) to account for this uneven pressure until the values of the high sensor areas 210a, 210b and the medium sensor area 220 are substantially equalized. The sensor areas 210a, 210b, 220 may be substantially equalized when the sensor measurements for the sensor areas 210a, 210b, 220 are less than a 30% difference from each other, less than a 20% difference, less than a 10% difference, less than a 5% difference, or being completely the same. The sensing matrix 200 may, therefore, contribute to providing an even pressure profile across an unfinished battery by providing information regarding which portions of the unfinished battery are receiving pressure that is too high or too low.

Where the sensing matrix 200 represents the temperature profile being applied to an unfinished battery, the pressing system may also be adjusted to provide a substantially even temperature profile. For example, the temperature of a heating plate (e.g., one or both of the heating plates 130a, 130b) and/or the angle of the first pressing platform (e.g., the first pressing platform 120a) may be adjusted to provide an even temperature profile. The sensing matrix 200 and/or sensor measurements from the film sensors may also be used to determine a potential contributing factor to the failure of a battery cell. For example, the sensing matrix 200 and/or sensor measurements from the film sensors can be used to determine whether a certain pressure and/or temperature profile may lead to an increased risk of battery cell failure. In this manner, those pressure and/or temperature profiles may be avoided or adjusted for future unfinished batteries.

In some embodiments, the sensing matrix 200 may include a predicted detection area 240 representing an area of the sensing matrix 200 that is predicted to receive sensor measurements corresponding to the unfinished battery. In this manner, the sensing matrix 200 may predict which portions of the sensor film should receive no or little sensor measurements outside of the predicted detection area 240 and that the portions within the predicted detection area 240 should receive a minimum level of sensor measurements. In other words, the sensing matrix 200 may predict the first low sensor area 230a outside of the predicted detection area 240 but may not predict the second low sensor area 230b inside of the predicted detection area 240. Accordingly, because the sensing matrix 200 includes the second low sensor area 230b, the sensing matrix 200 may indicate that the unfinished battery has an uneven sensor profile along the portion of the unfinished battery corresponding to the second low sensor area 230b. Specifically, the second low sensor area 230b may indicate that the portion of the unfinished battery corresponding to the second low sensor area 230b is receiving an insufficient temperature or pressure. The pressing mechanism or heating plate may be adjusted until all the sensor measurements within the predicted detection area 240 are substantially equal.

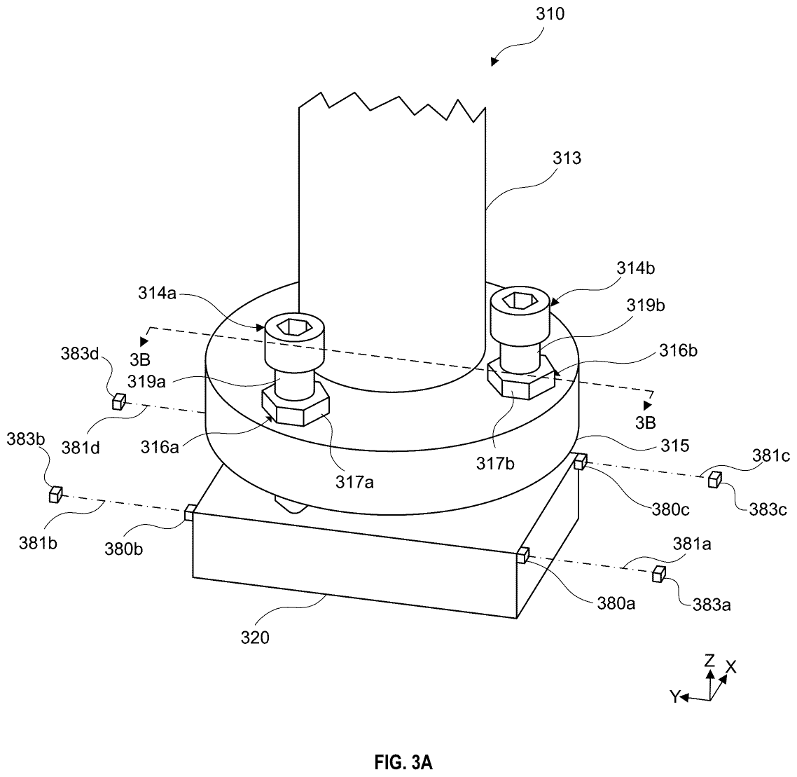

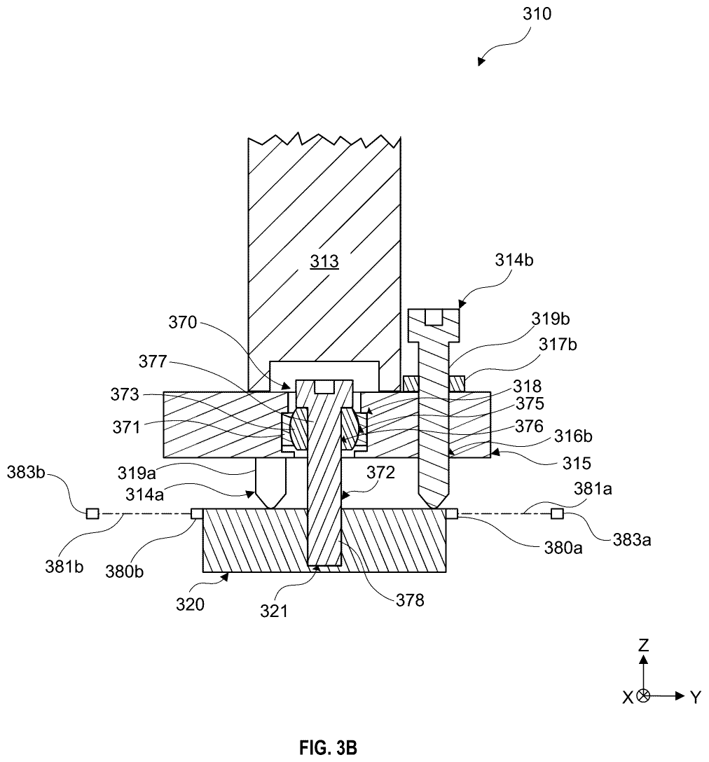

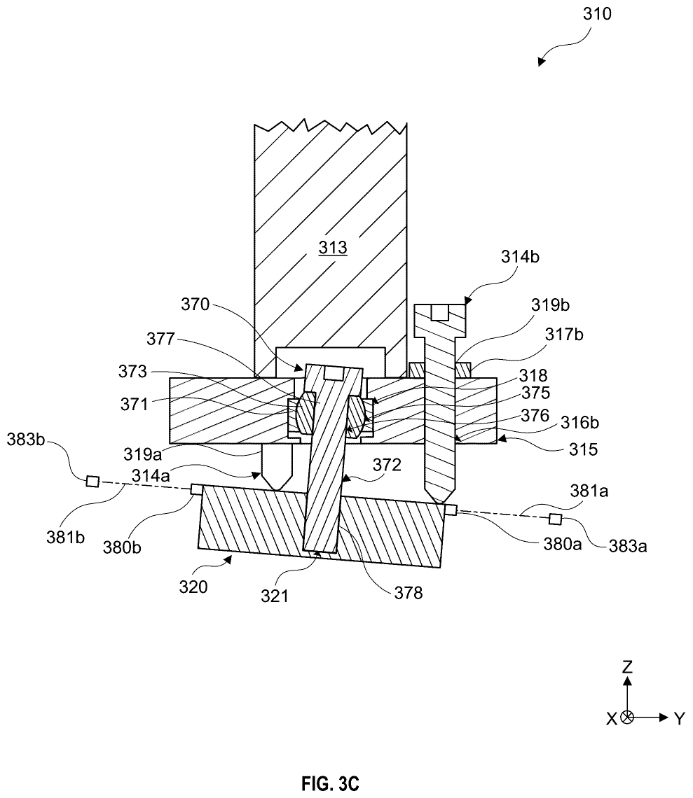

FIGS. 3A-3C depict a portion of a pressing system 310 that is part of a battery formation system. It is understood that features ending in like reference numerals as features discussed above are similar, except as noted below. Further, it is understood that FIGS. 3A-3C may include other components not shown, such as one or more components depicted in FIGS. 1A and 1B. Turning to FIG. 3A, the pressing system 310 may include a shaft 313 coupled to a press assembly (e.g., an adjustment plate 315 and motor, such as the motor 112 in FIG. 1B) via welding, brazing, soldering, gluing, fastening, or the like. The press assembly may be coupled to the first pressing platform 320 via a swivel system 370 (e.g., in FIG. 1B, the press assembly may be coupled between the shaft 113 and the first pressing platform 120a). The adjustment plate 315 may be a rigid metallic plate defining a first aperture 316a and a second aperture 316b. The apertures 316a, 316b may be sized and shaped to movably receive a first shaft 319a of a first adjustment fastener 314a and a second shaft 319b of a second adjustment fastener 314b therein. The first adjustment fastener 314a may be coupled to a first nut 317a and the second adjustment fastener 314b may be coupled to a second nut 317b. The adjustment fasteners 314a, 314b may be a screw, bolt, or the like. Each of the adjustment fasteners 314a, 314b may include similar features to each other. Although not shown, the adjustment plate 316 may define a third aperture to receive a corresponding third shaft of a third adjustment fastener (which would corresponding couple to a third nut), similar to the apertures 316a, 316b, adjustment fasteners 314a, 314b, and nuts 317a, 317b. In yet other embodiments, there may be any number of apertures and adjustment fasteners, like one, four, five, or the like. The adjustment fasteners 314a, 314b may be movable (e.g., the shafts 319a, 319b may be slidable) within the apertures 316a, 316b and may also be locked in place (e.g., through a nut and fastener system) to stably remain in a certain position. Accordingly, the adjustment fasteners 314a, 314b may be adjusted (e.g., by an operator, robotic manipulator, or other means) within the apertures 316a, 316b to a desired position and then locked in place. The adjustment fasteners 314a, 314b may be further unlocked, adjusted, and locked as desired. Each of the adjustment fasteners 314a, 314b may by unlocked or locked by rotating the corresponding nut 317a, 317b such that the nut 317a, 317b moves away from the adjustment plate 315 or couples against the adjustment plate 315 to lock the adjustment fasteners 314a, 314b in place.

The pressing system 310 may include a first laser emitter 380a, a second laser emitter 380b, and a third laser emitter 380c coupled to the first pressing platform 320. Each of the laser emitters 380a, 380b, 380c may be coupled to a corner of the first pressing platform 320. Although not shown, there may be a fourth laser emitter at a fourth corner (not shown) of the first pressing platform 320. However, in other embodiments, there may be more or less than four laser emitters, such as three, two, one, five, six, or the like. In yet other embodiments, the laser emitters may be coupled along any portion of the first pressing platform, such as along a face or edge of the first pressing platform. Each of the laser emitters 380a, 380b, 380c (as well as the fourth laser emitter) may emit a respective laser 381a, 381b, 381c, 381d. The lasers 381a, 381b, 381c, 381d may be respectively directed to a first laser detector 383a, a second laser detector 383b, a third laser detector 383c, and a fourth laser detector 383d. The laser detectors 383a, 383b, 383c, 383c can detect a change in angle of the lasers 381a, 381b, 381c, 381d. Specifically, the laser emitters 380a, 380b, 380c may be set to an initial position such that the lasers 381a, 381b, 381c, 381d are directed to an initial location along the laser detectors 383a, 383b, 383c, 383c. Any deviation along the laser detectors 383a, 383b, 383c, 383c by the lasers 381a, 381b, 381c, 381d from this initial location (e.g., a change in angle or length of lasers 381a, 381b, 381c, 381d) may be noted as a deviation of the laser emitters 380a, 380b, 380c (and, therefore, a deviation of an angle of the first pressing platform 320) from the initial position. For example, the initial position of the laser emitters 380a, 380b, 380c as shown in FIGS. 3A and 3B may be considered a first position (e.g., substantially parallel to a second pressing platform) and any deviation from this first position may be noted. Substantially parallel may mean a tilt (e.g., a difference between opposite ends of the first pressing platform 320 or a difference between the ends of the lasers 381a, 381b, 381c, 381d at the laser detectors 383a, 383b, 383c, 383c) of less than about 200 μm, such as less than about 150 μm, less than about 100 μm, less than about 50 μm, or completely parallel. It may be desirable to maintain the pressing platform 320 in a substantially parallel position when pressing the unfinished battery as doing so may lead to a more even pressure profile and, therefore, improved finished battery.

The laser emitters 380a, 380b, 380c and/or the laser detectors may be in communication with a computer system such that the laser emitters 380a, 380b, 380c and/or the laser detectors 383a, 383b, 383c, 383c may send a signal to the computer system when the lasers 381a, 381b, 381c, 381d deviate from the initial position. In this manner, the angle of the first pressing platform 320 may be detected based on the angle of the laser emitters 380a, 380b, 380c and the lasers 381a, 381b, 381c, 381d relative to the laser detectors. In some embodiments, there may be no laser emitters or laser detectors. Instead, the angle of the first pressing platform may be determined by a gyro sensor, accelerometer, or the like.

Turning to FIG. 3B, the adjustment plate 315 may define a mounting aperture 318 sized and shaped to receive at least a portion of the swivel system 370. The swivel system 370 may include a mounting component 371, a swivel fastener 372, and a swivel joint 373. The mounting component 371 may be coupled within the mounting aperture 318. The mounting component 271 may define a swivel aperture 375 sized and shaped to receive the swivel joint 373. The swivel joint 373 may be rotatable within the mounting component 371. The swivel joint 373 may define a fastener channel 376 to receive a first shaft portion 377 of the swivel fastener 372. The swivel fastener 372 may be locked within the swivel fastener 372 such that movement of the swivel joint 373 correspondingly moves the swivel fastener 372. However, in other embodiments, the swivel fastener may be unlockable to move within the fastener channel before being locked again.

The first pressing platform 320 defines a receipt aperture 321 to receive a second shaft portion 278. The first pressing platform 320 may be locked with the second shaft portion 378 such that movement of the swivel fastener 372 correspondingly moves the first pressing platform 320. In this manner, rotation of the swivel joint 373 within the swivel aperture 375 may rotate the swivel fastener 372 and the first pressing platform 320 in tandem. Accordingly, the first pressing platform 320 may be rotated about the swivel joint 373. However, in other embodiments, the first pressing platform may be unlocked from the second shaft portion and adjusted relative to the second shaft portion before being re-locked again.

The first pressing platform 320 may be freely rotatable via the swivel joint 373 before being locked in place by the adjustment fasteners 314a, 314b, 314c. In particular, the adjustment fasteners 314a, 314b, 314c may abut against the first pressing platform 320 to maintain the first pressing platform 320 in a particular fixed orientation. The orientation of the first pressing platform 320 may be adjusted by moving the adjustment fasteners 314a, 314b, 314c within the apertures 316a, 316b which, in turn, adjusts the orientation of the first pressing platform 320 by rotating the swivel joint 373 within the swivel aperture 375. For example, as will be discussed further below, the first pressing platform 320 may require adjustment when the first pressing platform 320 is adjusted to an initial position that is predicted to provide an even temperature and/or pressure profile to an unfinished battery prior to compressing the unfinished battery, an uneven pressure and/or temperature is detected while compressing the unfinished battery, or when the laser emitters 380a, 380b, 380c and/or laser detectors determine that the lasers 381a, 381b, 381c, 381d have deviated from an initial angle. Specifically, the orientation of the first pressing platform 320 may require adjustment from a first position, shown in FIGS. 3A and 3B, about the X-axis to a second position, shown in FIG. 3C. Each of the adjustment fasteners 314a, 314b may first be unlocked to allow for the adjustment fasteners 314a, 314b to move. The second adjustment fastener 314b may be moved down toward the first pressing platform 320 along the Z-axis and the first adjustment fastener 314a may be moved up away from the first pressing platform 320 along the Z-axis. The adjustment fasteners 314a, 314b may then be re-locked in place such that the orientation of the first pressing platform 320 may have the second position shown in FIG. 3C. In some embodiments, the pressing system 300 may include an actuating mechanism (not shown) coupled to each of the adjustment fasteners 314a, 314b, such as a servo motor or the like, so that the adjustment fasteners 314a, 314b may be individually adjusted automatically.

It should be understood that the second position depicted in FIG. 3C is merely illustrative and, in other embodiments, the adjustment fasteners and the first pressing platform may be adjusted as desired. In other embodiments, the swivel joint may be positioned in the first pressing platform, rather than the adjustment plate. As such, the first pressing platform may be angularly adjusted about the swivel joint without axially translating the first pressing platform. In this embodiment, the angle of the first pressing platform may be adjusted by adjusting a position of only one adjustment fastener as the first pressing platform does not axially translate. In yet other embodiments, the second pressing platform (e.g., the second pressing platform 120b) may also be angularly adjusted in a similar manner to the first pressing platform where a second swivel system similar to the first pressing platform is coupled to the second pressing platform.

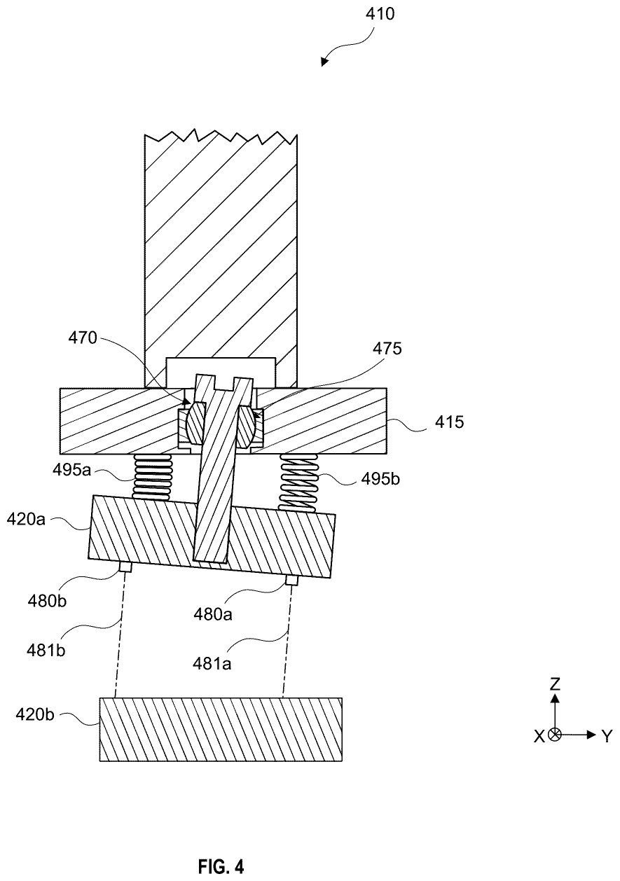

In other embodiments, the pressing system may use springs rather than adjustment fasteners to provide a more even pressure profile to the unfinished battery. For example, FIG. 4 depicts an example pressing system 410. It is understood that features ending in like reference numerals as features discussed above are similar, except as noted below. Further, it is understood that FIG. 4 may include other components not shown, such as one or more components depicted in FIGS. 1A and 1B. Rather than adjustment screws, as shown in FIGS. 3A-3C, the pressing system 410 may include a first spring 495a and a second spring 495b coupled between the adjustment plate 415 and the first pressing platform 420a. Although only two springs 495a, 495b are shown, in other embodiments, there may be more or less than two springs, such as three springs, four springs, or the like.

The swivel system 470 may be rotatable within the swivel aperture 475 such that the first press platform 420a may rotate when interacting with an uneven (e.g., tilted) unfinished battery. Specifically, interacting with the uneven unfinished battery may push the first platform 420a into an uneven position. At the same time, the springs 495a, 495b may bias the first pressing platform 420a into an initial position (e.g., similar to the position of the pressing platform 320 in FIG. 3B). In this manner, should the first pressing platform 420a be pushed to an uneven position, the spring force of the springs 495a, 495b may ensure that each portion of the first pressing platform 420a may push against the unfinished battery to apply a more even pressure profile to the unfinished battery.

For example, the first pressing platform 420a depicted in FIG. 4 may have interacted with an uneven unfinished battery and, accordingly, may have been pushed into an uneven position. In this uneven position, the springs 495a, 495b may apply a persistent spring force to the first pressing platform 420a no matter the orientation of the first pressing platform 420a. In this manner, a more even pressure profile may be applied to the unfinished battery. In other embodiments, the pressing system may include both the springs and the adjustment fasteners. In a yet further embodiment, the pressing system may additionally or alternatively include other features that orient the first pressing platform into a particular orientation, such as one or more pistons coupled between the first pressing platform and the adjustment plate, or the like.

The pressing system 410 may also include laser emitters 480a, 480b emitting lasers 481a, 481b. Rather than emitting lasers in a generally X-direction or Y-direction (as shown in FIGS. 3A-3C for laser emitters 380a, 380b, 380c, 380d for lasers 381a, 381b, 381c, 381d), the laser emitters 480a, 480b may emit lasers 481a, 481b in a generally Z-direction. Specifically, the laser emitters 480a, 480b may emit lasers 481a, 481b toward the second pressing platform 420b. The second pressing platform 420b may include one or more laser detectors along a portion of the second pressing platform 420b (e.g., along a surface of the second pressing platform 420b facing the first pressing platform 420a). Accordingly, the angle of the first pressing platform 420a may be determined by a determined by the lasers 481a, 481b (e.g., the angle or distance of the lasers 481a, 481b) relative to the second pressing platform 420b. For example, the first pressing platform 420a may be set to a first position (e.g., similar to the orientation of the pressing platform 320 in FIG. 3B) with the lasers 481a, 481b emitted toward the second pressing platform 420 in a substantially Z-direction. In this first position, the first pressing platform 420a may be substantially parallel when the difference in lengths between the lasers 481a, 481b are less than about 200 μm, such as less than about 150 μm, less than about 100 μm, less than about 50 μm, or completely parallel. The first pressing platform 420a may then be moved from this first position when interacting with an uneven unfinished battery and may be moved, along with the lasers 481a, 481b, to a second position, as shown in FIG. 4. The laser emitters 480a, 480b and/or the laser detectors of the second pressing platform 420b may send a signal to a computer system that the lasers 481a, 481b have deviated from the first position and may need further adjustment.

As discussed previously, the pads coupled to the first pressing platform (e.g., the pads 160a, 160b shown in FIG. 1B) may be compliant pads that conform to an exterior surface of the unfinished battery. As noted above, various issues may arise when an uneven pressure is applied to an unfinished battery that is being compressed. A compliant pad having conformal surfaces may more evenly distribute the pressure along the unfinished battery. FIG. 5 depicts an example pressing system 510 of a battery formation system. It is understood that features ending in like reference numerals as features discussed above are similar, except as noted below. The battery formation system 500 may include pads 560a, 560b having a corresponding first and second conformal surfaces 561a, 561b that are shaped to conform to top and bottom surfaces 503, 504 of the unfinished battery 502. The pads 560a, 560b may have a hardness and thickness configured, with the conformal surfaces 561a, 561b, to provide an even pressure profile to the unfinished battery 502. The pads 560a, 560b may be made of a rubber, such as silicone, however other types of materials are envisioned.

The conformal surfaces 561a, 561b may be shaped to correspond to the unfinished battery 502 prior to compressing the unfinished battery 502. Specifically, the pads 560a, 560b may be preconformed to a known shape that most likely corresponds to the unfinished battery 502. The known shape may be a predicted geometry of the unfinished battery 502 based on other iterations of unfinished batteries (e.g., using a finite element analysis). In this manner, the pads may provide a more customized shape for the exterior surface of the unfinished battery. This may be particularly beneficial where the unfinished battery may have an abnormal shape (e.g., an L-shape, curved, twisted, or the like). In yet other embodiments, one of the pads may be preconformed while the other is not. In some embodiments, neither of the pads may have a conformal surface. In other embodiments, the pads may not be preconformed and, instead, may be softer than the pads 560a, 560b such that the pads may conform to the shape of the unfinished battery in real-time. In other words, in this example, the pads may conform to the unfinished battery as the pads compress against the unfinished battery. This may be beneficial where the shape of the unfinished battery is unknown prior to compressing the unfinished battery.

The pads 560a, 560b may have a width and length larger than the unfinished battery 502 such that the conformal surfaces 561a, 561b encompass the edges of the unfinished battery. This may ensure that the entire top and bottom surfaces 503, 504 of the unfinished battery 502 may receive an even distribution of pressure. This may be beneficial when the unfinished battery 502 has a pouch enclosure as the pouch enclosure is pliable, thus allowing for the pads 560a, 560b to more evenly distribute pressure by encompassing the edges of the battery cell in the unfinished battery 502. However, in other embodiments, the pads may have conformal surfaces less than the size of the unfinished battery (e.g., as shown in pads 160a, 160b of FIG. 1B). This may be beneficial where the unfinished battery is in a can cell and the conformal surfaces can focus the pressure to just the battery cell within the unfinished battery.

Compressing unfinished batteries with the above-described pressing systems 110, 310, 410, 510 may provide a battery cell having more uniform adhesion between layers. FIG. 6 depicts an example battery cell 602. It is understood that features ending in like reference numerals as features discussed above are similar, except as noted below. The battery 602 may be a finished battery after an unfinished battery has been compressed. The battery cell 602 may include a battery enclosure 605 and a battery cell 606. The layers of the battery cell 606 may be substantially uniform. For example, the layers of the battery cell 606 may be substantially uniform when the layers have a pressure variance about the less than or about 450 kPa²/mm, across the layers, such as less than or about 350 kPa²/mm, such as less than or about 250 kPa²/mm, such as less than or about 150 kPa²/mm, such as less than or about 50 kPa²/mm, or no pressure variance across the layers. The layers of the battery cell 606 may also be substantially uniform when the layers have a pressure range of less than or about 850 kPa/mm, such as less than or about 650 kPa/mm, such as less than or about 450 kPa/mm, such as less than or about 250 kPa/mm, such as less than or about 50 kPa/mm, or no pressure range across the layers. This uniformity value may be a direct result of the pressing systems 110, 310, 410, 510 and battery formation system 100 as described above, and the methods using those pressing systems 110, 310, 410, 510 as described below

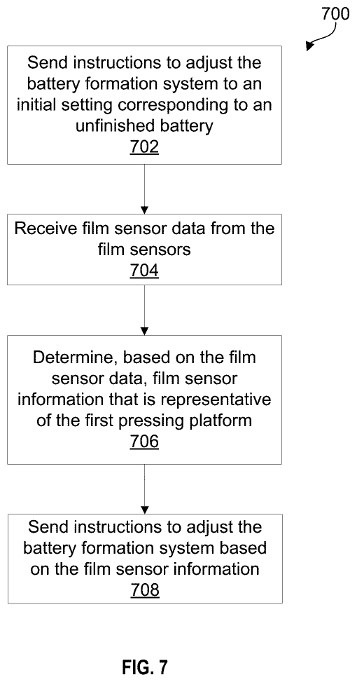

FIG. 7 depicts an example flowchart 700 for forming a battery using a computer system. It is understood that features ending in like reference numerals as features discussed above are similar, except as noted below. The following steps may be performed as instructions sent by a computer system however, in other embodiments, the following may be performed by a human operator. Turning to step 702, the computer system may send instructions to adjust the battery formation system to an initial setting corresponding to an unfinished battery. With specific reference to FIGS. 1A and 1B, the battery formation system 100 may be adjusted to an initial setting to accommodate an unfinished battery 102. The battery formation system 110 may be adjusted to the initial setting prior to placing the unfinished battery 102 within the battery formation system 100. For example, the computer system 180 may receive information regarding the unfinished battery 102, including whether the unfinished battery 102 includes a battery cell in a wound battery cell configuration, the dimensions of the unfinished battery 102, the type of enclosure of the unfinished battery 102 (e.g., whether the enclosure is a pouch or a can), the temperature and pressure settings to be used for compressing and heating the unfinished battery 102, and/or the angle of the first pressing platform 120a for use in compressing the unfinished battery 102. At least some of the received information may be information that is predicted to correspond to the unfinished battery 102 based on previous iterations of forming unfinished batteries.

For example, the temperature and pressure settings, and the angle of the first pressing platform 120a, may be a part of a set of initial settings predicted to provide an even pressure and temperature profile for the unfinished battery 102. In another example, using finite element analysis, the unfinished battery 102 may have a predicted size and shape. The pads 160a, 160b may be provided to correspond to the predicted size and shape of the unfinished battery 102. The pads 160a, 160b may be a compliant pad that is smaller than the unfinished battery 102 (e.g., where the enclosure of the unfinished battery 102 is a can), however, in other embodiments, the pads may encompass the edges of the unfinished battery 102, such as the pads 460a, 460b for a pouch enclosure.

In some embodiments, the angle of the first pressing platform 120a may require adjustment according to the set of initial settings for the unfinished battery 102 prior to compressing the unfinished battery 102 For example, turning to FIGS. 3A-3C, the first pressing platform 320 may be adjusted from a first position shown in FIGS. 3A and 3B to a second position shown in FIG. 3C. Specifically, the adjustment fasteners 314a, 314b may be unlocked and adjusted within the apertures 316a, 316b along the Z-axis. Each of the adjustment fasteners 314a, 314b may be individually adjusted by a robotic manipulator (e.g., the manipulator 190), a human operator, or through an actuating mechanism coupled to the adjustment fasteners 314a, 314b. Adjusting the adjustment fasteners 314a, 314b may rotate the swivel joint 373 within the swivel aperture 375 such that the first pressing platform 320 may be adjusted from the first position to a second position (e.g., a starting position for compressing the unfinished battery), such as the position of the first pressing platform 320 in FIG. 3C. In this second position, the angle of the laser emitters 380a, 380b, 380c and lasers 381a, 381b, 381c, 381d may be set such that any deviation from this angle may be sent as a signal to the computer system to potentially further adjust the first pressing platform 320. For example, the angle of the laser emitters 380a, 380b, 380c and lasers 381a, 381b, 381c, 381d relative to the laser detectors may be noted by the computer system to detect any deviation from this noted angle. Alternatively or additionally, turning to FIG. 4, a change in length of the lasers 481a, 481b (e.g., a distance between the laser emitters 480a, 480b and a corresponding laser detector in the second pressing platform 420b) can be used to determine the change in angle between the first pressing platform 420a and the second pressing platform 420b. This change in length can be used by the computer system to determine a change in position of the first pressing platform 420a.

Turning back to FIGS. 1A and 1B, once the pressing system 110 is set according to the initial settings, the first pressing platform 120a may be read to compress the unfinished battery 102. Turning specifically to FIG. 1A, each of the battery formation systems 110a, 110b, 110c may be adjusted in in a similar manner in preparation to compress an unfinished battery. In some embodiments, only some of the above features may be adjusted. For example, less than all of the pressure settings, heat settings, pads, or angle of the first pressing platform may be adjusted in anticipation of compressing the unfinished battery. The unfinished battery 102 may then be positioned in the battery formation system. For example, the manipulator 190 may position the unfinished battery 102 onto the second pad 160b. The servo motor 112 may move then the shaft 113 and the first pressing platform 120a, with the first heating plate 130a and the film sensors 140a, 150a, toward the unfinished battery 102 so that the first pad 160a compresses the unfinished battery 102 against the second pad 160b. In some embodiments, turning to FIG. 4, the first pressing platform 420a may be adjusted from a first orientation to a second orientation as the first pressing platform 420a interacts with the unfinished battery.

Turning to Step 704, the computer system may receive film sensor data from the film sensors. For example, turning back to FIGS. 1A-1C, as the unfinished battery 102 is being compressed, the pressure film sensors 150a, 150b and the laser emitters/detectors (e.g., the laser emitters 380a, 380b, 380c and/or the laser detectors shown in FIG. 3C) may send signals to the computer system 180 regarding the temperature and pressure profiles being applied against the unfinished battery 102 as well as whether the angle of the first pressing platform 120a changes.

Turning to Step 706, the computer system may determine, based on the film sensor data, film sensor information that is representative of the first pressing platform. For example, the computer system 180 may receive pressure measurements from the pressure film sensors 150a, 150b and may generate a sensing matrix based on those pressure measurements. Turning to FIG. 2, the sensing matrix 200 may represent the pressure profile applied against one surface of the unfinished battery (e.g., the sensing matrix 200 may only represent the pressure profile of one of the film sensors 150a, 150b).

In one example, the computer system may determine that the unfinished battery 102 is receiving an uneven pressure profile. For example, the computer system may receive pressure measurements from the film sensors that indicate that the unfinished battery is receiving higher pressure at some portions and low pressure at others. In particular, the high sensor areas 210a, 210b may indicate that the unfinished battery is receiving higher pressure along the high sensor areas 210a, 210b compared to the portions of the unfinished battery corresponding to the medium sensor area 220. Further, the second low sensor area 230b being within the predicted detection area 240 may indicate that the unfinished battery is receiving insufficient pressure along the areas of the unfinished battery corresponding to the second low sensor area 230b. In other embodiments, the computer system may not generate a sensing matrix and may, instead, just note which portions of the pressure film sensors have lower or higher relative sensor measurement values. The computer system may conduct a similar analysis for other film sensors (e.g., the second pressure film sensor 150b), if there are other film sensors.

Turning to FIGS. 3A-3C, the computer system may also determine whether the first pressing platform 320 has changed in angle. For example, the laser emitters 380a, 380b, 380c and/or the laser detectors may send a signal that the angle of the first pressing platform 320 has changed from the initial position. The computer system may determine that the first pressing platform 320 is applying uneven pressure to the unfinished battery when the changed angle provided by the laser emitters 380a, 380b, 380c and/or the laser detectors is higher than a threshold amount (e.g., the angle changes by more than about 3%, by more than about 5%, by more than about 10%, or the like).

Turning to step 708, the computer system may send instructions to adjust the battery formation system based on the film sensor information. For example, the computer system may adjust the angle of first pressing platform 320 to accommodate the uneven pressure (e.g., decreasing pressure on the unfinished battery where the computer system determined that the pressure was too high and/or increasing pressure on the unfinished battery where the computer system determined that the pressure was too low). The first pressing platform 320 may be adjusted from the initial position when the first pressing platform 320 began compressing the unfinished battery to an adjusted position that provides a more even pressure profile by moving the adjustment fasteners 314a, 314b. For example, the first adjustment fastener 314a may be adjusted within the first aperture 316a down toward the first pressing platform 320 along the Z-axis to angle the first pressing platform 320 down in that direction and increase the pressure applied to the unfinished battery. The second adjustment fastener 314b may be adjusted within the second aperture 316b up away from the first pressing platform 320 along the Z-axis to allow the first pressing platform 320 to be angled away from the unfinished battery and decrease the pressure applied to the unfinished battery. The angle of the laser emitters 380a, 380b, 380c may be set again such that the laser emitters 380a, 380b, 380c and/or the laser detectors may send a signal to the computer system of the angular deviations of the first pressing platform 320 in this adjusted position.

In another embodiment, the computer system may not adjust any features of the pressing system 310. Instead, the unfinished battery may continue to be compressed and the information regarding the uneven pressure (e.g., the settings of the pressing system 310) may be stored and/or sent to a different computing system. This information may be used to adjust the settings of the pressing system 310 for later iterations of compressing unfinished batteries rather than the unfinished battery being pressed.

Turning back to FIG. 1B, after the unfinished battery 102 is compressed, the unfinished battery 102 may be heated by the heating plates 130a, 130b. The computing system may generate a sensing matrix (e.g., similar to the sensing matrix 200) corresponding to the temperature measurements provided by each of the temperature film sensors 140a, 140b. The computing system may determine that the unfinished battery 102 is receiving an uneven temperature profile from the heating plates 130a, 130b based on at least one of the temperature measurements or the sensing matrix. To account for the uneven temperature, the computer system may then adjust at least one of the temperatures of the heating plates 130a, 130b and/or the angle of the first pressing platform 120a, as described above. For example, the first pressing platform 120a may be angled toward areas of the unfinished battery 102 that the computer system determines is not receiving enough heat and may be angled away from areas of the unfinished battery 102 that the computer system determines is receiving too much heat. In another example, the temperature of one of the heating plates 130a, 130b (e.g., the second heating plate 130b) may be adjusted to offset the temperature of the other heating plate 130a, 130b (e.g., the first heating plate 130a). Although the unfinished battery 102 may be heated after the unfinished battery 102 is compressed, in other embodiments, the unfinished battery may be heated before or during compression.

The process described in flowchart 700 for forming a battery may result in a battery with layers adhered to each other with greater uniformity. For example, turning to FIG. 6, the process may produce a battery 602 with substantially uniform layers. This greater uniformity increases how strongly each layer is adhered to each other and, therefore, increases the performance and longevity of the battery 602.

Any of the computer systems mentioned herein may utilize any suitable number of subsystems. Examples of such subsystems are shown in FIG. 7 in computer system 710. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

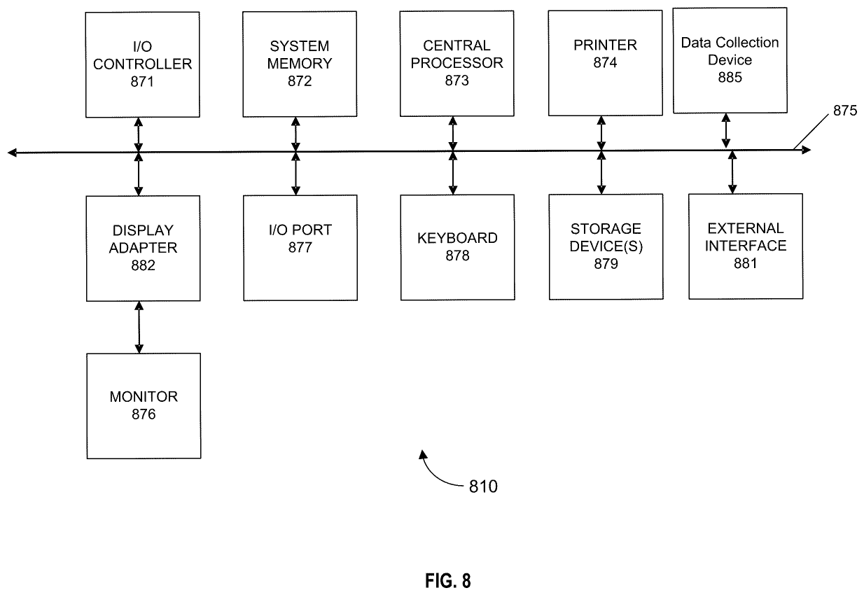

The subsystems shown in FIG. 8 are interconnected via a system bus 875. Additional subsystems such as a printer 874, keyboard 878, storage device(s) 879, monitor 876 (e.g., a display screen, such as an LED), which is coupled to display adapter 882, and others are shown. Peripherals and input/output (I/O) devices, which couple to I/O controller 871, can be connected to the computer system by any number of means known in the art such as input/output (I/O) port 877 (e.g., USB, Fire Wire®). For example, I/O port 877 or external interface 881 (e.g., Ethernet, Wi-Fi, etc.) can be used to connect computer system 810 to a wide area network such as the Internet, a mouse input device, or a scanner. The interconnection via system bus 875 allows the central processor 873 to communicate with each subsystem and to control the execution of a plurality of instructions from system memory 872 or the storage device(s) 879 (e.g., a fixed disk, such as a hard drive, or optical disk), as well as the exchange of information between subsystems. The system memory 872 and/or the storage device(s) 879 may embody a computer readable medium. Another subsystem is a data collection device 885, such as a camera, microphone, accelerometer, and the like. Any of the data mentioned herein can be output from one component to another component and can be output to the user.

A computer system can include a plurality of the same components or subsystems, e.g., connected together by external interface 881, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor (e.g., aligning, determining, comparing, computing, calculating) may be performed in real-time. The term “real-time” may refer to computing operations or processes that are completed within a certain time constraint. The time constraint may be 1 minute, 1 hour, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A battery formation system, comprising:
a first pressing platform;
a second pressing platform;
a press assembly configured to move the first pressing platform towards the second pressing platform to apply a pressing force on an unfinished battery, wherein the first pressing platform is coupled to the press assembly and rotatable relative to the second pressing platform;
a pressure film sensor coupled to the pressing platform and configured to output pressure data corresponding to the pressing force; and
a computer system in communication with the pressure film sensor, wherein the computer system includes one or more computer processors configured to:
receive the pressure data from the pressure film sensor;
determine, based on the pressure data, pressure information that is representative of the first pressing platform; and
send instructions to adjust an angle of the first pressing platform based on the pressure information.

2. The battery formation system of claim 1,
further comprising a laser emitter coupled to the pressing platform and in communication with the computer system,
wherein:
the laser emitter is configured to output angle data corresponding to an angle of the first pressing platform; and
the one or more computer processors are configured to:
receive the output angle data from the laser emitter;
determine, based on the output angle data, position information that is representative of the first pressing platform; and
send instructions to adjust the angle of the first pressing platform based on the position information.

3. The battery formation system of claim 2, wherein the laser emitter is coupled to a corner of the first pressing platform.

4. The battery formation system of claim 1,
further comprising a first compliant pad coupled to the first pressing platform and a second compliant pad coupled to the second pressing platform, and
wherein the press assembly is configured to move the first compliant pad toward the second compliant pad to apply the pressing force on the unfinished battery.

5. The battery formation system of claim 1, further comprising a heating plate coupled to the first pressing platform, wherein the heating plate is configured to provide heat to the unfinished battery at a temperature.

6. The battery formation system of claim 5, further comprising a temperature film sensor coupled to the heating plate and in communication with the computer system,
wherein:
the temperature film sensor is configured to output temperature data corresponding to the temperature of the heat provided by the heating plate to the unfinished battery; and
the one or more computer processors are configured to:
receive the output temperature data from the temperature film sensor;
determine, based on the output temperature data, temperature information that is representative of the heating plate; and
send instructions to adjust at least one of: (i) the angle of the first pressing platform based on the temperature information, and (ii) the temperature of the heating plate.

7. The battery formation system of claim 1, further comprising a second pressure film sensor coupled to the second pressing platform, wherein the second pressure film sensor is configured to output second pressure data corresponding to the pressing force.

8. The battery formation system of claim 1,
further comprising:
an adjustment plate coupled to the press assembly;
a swivel joint rotatably received in the adjustment plate; and
a swivel fastener coupled to the swivel joint,
wherein the first pressing platform is coupled to the swivel fastener.

9. The battery formation system of claim 8, further comprising a plurality of adjustment fasteners movably received in the adjustment plate, wherein the first pressing platform abuts against the plurality of adjustment fasteners.

10. The battery formation system of claim 9, wherein:
in a first state, the first pressing platform is in a first angle relative to the second pressing platform and the plurality of adjustment fasteners are in a first position relative to the adjustment plate;
in a second state, the second pressing platform is in a first angle relative to the second pressing platform and at least one adjustment fastener of the plurality of adjustment fasteners is in a second position relative to the adjustment plate; and
the first angle and the first position are respectively different than the second angle and the second position.

11. A battery formation system, comprising:
a first pressing platform;
a second pressing platform;
a press assembly configured to move the first pressing platform towards the second pressing platform to apply a pressing force on an unfinished battery, wherein the first pressing platform is coupled to the press assembly and rotatable relative to the second pressing platform;
a pressure sensor matrix coupled to the pressing platform and configured to output pressure data corresponding to the pressing force; and
a laser emitter coupled to the first pressing platform and configured to output angle data corresponding to an angle of the first pressing platform.

12. The battery formation system of claim 11, wherein the laser emitter is coupled to a corner of the first pressing platform.

13. The battery formation system of claim 11, further comprising a first compliant pad coupled to the first pressing platform and a second compliant pad coupled to the second pressing platform, and
wherein the press assembly is configured to move the first compliant pad toward the second compliant pad to apply the pressing force on the unfinished battery.

14. The battery formation system of claim 11, further comprising a heating plate coupled to the first pressing platform, wherein the heating plate is configured to provide heat to the unfinished battery.

15. The battery formation system of claim 14, further comprising a temperature film sensor coupled to the heating plate and in communication with a computer system, wherein the temperature film sensor is configured to output temperature data corresponding to the heat provided by the heating plate to the unfinished battery.

16. The battery formation system of claim 11, further comprising a second pressure film sensor coupled to the second pressing platform, wherein the second pressure film sensor is configured to output second pressure data corresponding to the pressing force.

17. The battery formation system of claim 11, further comprising:
an adjustment plate coupled to the press assembly;
a swivel joint rotatably received in the adjustment plate; and
a swivel fastener coupled to the swivel joint,
wherein the first pressing platform is coupled to the swivel fastener.

18. The battery formation system of claim 17, further comprising a plurality of adjustment fasteners movably received in the adjustment plate, wherein the first pressing platform abuts against the plurality of adjustment fasteners.

19. The battery formation system of claim 18, wherein:
in a first state, the first pressing platform is in a first angle relative to the second pressing platform and the plurality of adjustment fasteners are in a first position relative to the adjustment plate;
in a second state, the second pressing platform is in a first angle relative to the second pressing platform and at least one adjustment fastener of the plurality of adjustment fasteners is in a second position relative to the adjustment plate; and
the first angle and the first position are respectively different than the second angle and the second position.

20. A battery, comprising:
a battery enclosure defining an interior volume; and
a battery cell positioned in the interior volume, wherein:
the battery cell includes a first active material layer, a second active material layer, and a separator layer coupled between the first active material layer and second active material layer;
the first active material layer, second active material layer, and the separator are rolled such that the battery cell forms a wound battery cell configuration; and
the battery cell includes a plurality of layers that are substantially 9 uniform.
